(19) United States
(12) Patent Application Publication
(10) Pub. No.: US 2008/0004782 A1
(43) Pub. Date: Jan. 3, 2008

(54) Method of processing time distribution in real time operating system

(76) Inventors: Keita Kobayashi, Okasa (JP); Yusuke Ito, Osaka (JP); Naoya Ichinose, Osaka (JP); Youko Matsushima, Osaka (JP); Ryoko Morita, Osaka (JP); Toshio Sasaoka, Osaka (JP)

Correspondence Address: MCDERMOTT WILL & EMERY LLP, 600 13TH STREET, NW, WASHINGTON, DC, 20005-3096, US

(21) Appl. No.: 11/798,368

(22) Filed: May 14, 2007

(30) Foreign Application Priority Data
May 15, 2006 (JP) 2006-134915

(51) Int. Cl. G06F 17/00

(52) U.S. Cl. 701/66

(57) ABSTRACT

A processing time necessary from start by end of processing of a first processing group and a second processing group is calculated. A time difference between a dead line previously set as a maximum tolerance value of the processing time necessary by completion of the processing of the first processing group, and the calculated processing time is calculated. An initial value of a processing time allowable value of the second processing group is calculated based on the time difference. The processing time allowable value is updated at the time of processing in the operating system. It is judged whether or not the second processing group can be executable based on the updated processing time allowable value.

### BACKGROUND OF THE INVENTION

1. Field of the Invention

The present invention relates to a method of processing time distribution in a real time operating system, more specifically to a technology for improving a processing efficiency in a whole real time operating system including a first processing group where there is a time restriction until completion of the processing and a second processing group without any restriction until completion of the processing.

2. Description of the Related Art

An installation system is a computer system installed in various machines and devices so as to control them, and a number of technical fields where they are applied is expanded rapidly in recent years. Further, a scale of software is becoming larger and the software is increasingly complicated as the technology advances, and it is now indispensable to use the real time operating system.

As a key indicator of the real time operating system, it is an important issue to guarantee a real time performance. Generally, the real time performance is means to guarantee impletion of the restriction in a state where such a restriction that a processing must be processed within a certain period of time is imposed. In any processing where the real time performance is demanded, it is an indispensable factor for the started processing to be terminated within a predictable time. The time limit is particularly called a dead line, which is an important indicator in the real time operating system.

FIG. 8 shows an example of the processing in the real time operating system. In the system shown in FIG. 8, a first processing group A having tasks T1 and T2 where a dead line leading up to completion of the processing is set, and a second processing group B without any dead line leading up to completion of the processing and consisting of an interruption I1 are processed on the real time operating system.

In the system, the priority of the dead-line-free second processing group B is lowered so that the real time performance of the first processing group A having the dead line is guaranteed. In the foregoing case, however, an execution time of an idle task that is not effectively processed by a CPU is increased, which results in a poor processing efficiency. In FIG. 8, the second processing group B is allowed to be operated only during until Timing T6 after Timing T1 when the processing of the first processing group A is completed. Accordingly, the processing efficiency is poor because the idle task is allowed to operate only between the periods T1-T2, T3-T4 and T5-T6.

As a conventional technology for solving such a problem, as recited in No. 2004-171588 of the Japanese Patent Applications Laid-Open, it is judged whether or not the actual execution time satisfies the dead line, and detection is carried out as an abnormal state when the actual execution time exceeds the dead line.

However, the conventional technology is disadvantageous in that it can only be judged if the first processing group A is completed by the dead line in the system including the first processing group A having the dead line for the processing to be completed and the second processing group B without any dead line for the processing to be completed, and it is not possible to guarantee the improvement of the processing efficiency of the second processing group B. In other words, it is not possible to guarantee the dead line of the first processing group A while efficiently distributing the processing time Of the second processing group B.

### SUMMARY OF THE INVENTION

Therefore, a main object of the present invention is to provide a method of efficiently executing a dead-line-free processing while guaranteeing the completion of a processing having the dead line within a dead line.

In a real time operating system including a first processing group having a dead line leading up to completion of the processing and a second processing group without any dead line leading up to completion of the processing, a method of processing time distribution according to the present invention comprises the steps:
a first step for calculating a processing time necessary from start-up to completion of processing in the first processing group and the second processing group;
a second step for calculating a time difference between a dead line set previously as a maximum tolerance value of the processing time necessary for completion of the processing of the first processing group and the processing time;
a third step for setting an initial value of an processing time allowable value of the second processing group based on the time difference;
a fourth step for updating the processing time allowable value at the time of processing in the operating system; and
a fifth step for judging whether or not the second processing group can be processed based on the updated processing time allowable value.

It is preferable that a maximum value of the processing time necessary from the start-up by the completion of the processing is calculated as the processing time in the first and second processing groups respectively in the first step.

Additionally, in the above description, it is preferable that the processing time allowable value in the second processing group and the processing time are compared to each other at the time of the processing in the operating system, and it is judged that the second processing group is executable when the processing time allowable value is larger, in the fifth step.

In the present invention, the processing time allowable value of the second processing group is updated every time when the second processing group is implemented, and it is judged whether or not the processing of the next second processing group can be implemented based on the updated processing time allowable value. Accordingly, the judgment can be made in a more detailed manner, and the second processing group free of any dead line can be efficiently allocated to a CPU while the dead line of the first processing group is guaranteed at the same time. As a result, a processing efficiency of the whole system can be improved.

Besides, there is also an embodiment that processable number of times in the second processing group can be processed is calculated from the time difference, and the calculated number of times is set as an initial value of the processing time allowable value of the second processing group in the third step, and

it is judged that the second processing group is executable when the processing time allowable value is at least zero in the fifth step.

In the foregoing constitution wherein the judgment is made based on the processable number of times when the second processing group can be processed, it becomes unnecessary to calculate the processing time from the processing start in the first processing group to interruption, and the processing time of the second processing group. As a result, the control operation can be facilitated.

Moreover, there is an embodiment that a plurality of processing time allowable values is prepared, and then a calculation method of the processing time allowable values are is changed when it is judged that the second processing group is not executable based on the processing time allowable values in the fifth step. In short, by changing a calculation method of the processing time allowable values to enable the execution of the second processing group as much as possible. As a result, the detailed control can be achieved.

Furthermore, it may be assumed that the time of the processing in the operating system is the time of the processing for changing a context to the first processing group after the processing of the second processing group, or the time of the processing in the operating system is the time when the processing is shifted to the operating system during the processing of the first processing group.

It is preferable that an actual processing time of the second processing group necessary from the start-up to the completion of the processing thereof is measured, and the processing time allowable value is updated based on the measured actual processing time of the second processing group in the fourth step. As a result, the detailed control can be achieved.

Additionally, it is also preferable that, in the fourth step, maximum value on a processing time of the first processing group necessary from the start-up of the processing thereof up to a time point when the processing is shifted to the operating system is calculated,

an actual processing time of the first processing group necessary from the start-up of the processing thereof up to the time point when the processing is shifted to the operating system is measured, and

the processing time allowable value is updated based on the maximum value on the processing time and the actual processing time of the first processing group. As a result, the detailed control can be achieved.

A device for processing time distribution in a real time operating system according to the present invention comprises:

a processing time calculator for calculating a processing time necessary from start-up to completion of processing in a first processing group having a dead line leading up to completion of the processing and a second processing group without any dead line leading up to completion of the processing;

a time difference calculator for calculating a time difference between a dead line set previously as a maximum tolerance value of the time necessary by completing the processing in the first processing group and the processing time;

a processing time allowable value calculator for calculating a processing time allowable value of the second processing group based on the calculated time difference; and

a judger for changing a state of the system by judging whether or not the second processing group is executable based on the calculated processing time allowable value.

According to the present invention, the processing of the second processing group free of any dead line can be efficiently distributed to the CPU while the dead line of the first processing group is guaranteed at the same time. As a result, the processing efficiency of the whole system can be improved.

In the method and the device for distributing the processing time in the real time operating system according to the present invention, since it is capable of efficiently distributing the processing of the second processing group free of any dead line to the CPU while guaranteeing the dead line of the first processing group, it is useful, for example, as a technology for improving a processing efficiency of a whole system.

### BRIEF DESCRIPTION OF THE DRAWINGS

These and other objects as well as advantages of the invention will become clear by the following description of preferred embodiments of the invention. A number of benefits not recited in this specification will come to the attention of those skilled in the art upon the implementation of the present invention.

FIG. 1 shows a system configuration of a method for distributing processing time in a real time operating system according to a preferred embodiment 1 of the present invention.

FIG. 2 is a timing chart illustrating a processing flow according to the preferred embodiment 1.

FIG. 3 shows a system configuration of a method for distributing processing time in a real time operating system according to a preferred embodiment 2 of the present invention.

FIG. 4 is a timing chart illustrating a processing flow according to the preferred embodiment 2.

FIG. 5 shows a system configuration of a method for distributing processing time in a real time operating system according to a preferred embodiment 3 of the present invention.

FIG. 6 is a timing chart illustrating a processing flow according to the preferred embodiment 3.

FIG. 7 is a flow chart illustrating procedure steps in the methods for distributing processing time in the real time operating systems according to the preferred embodiments 1-3.

FIG. 8 is a flow chart illustrating processing flow in a method for distributing processing time in a real time operating systems according to a conventional technology.

### DETAILED DESCRIPTION OF THE INVENTION

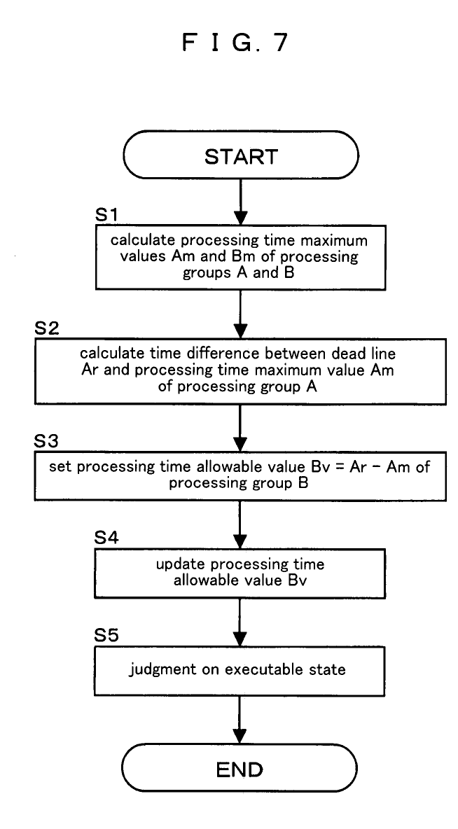

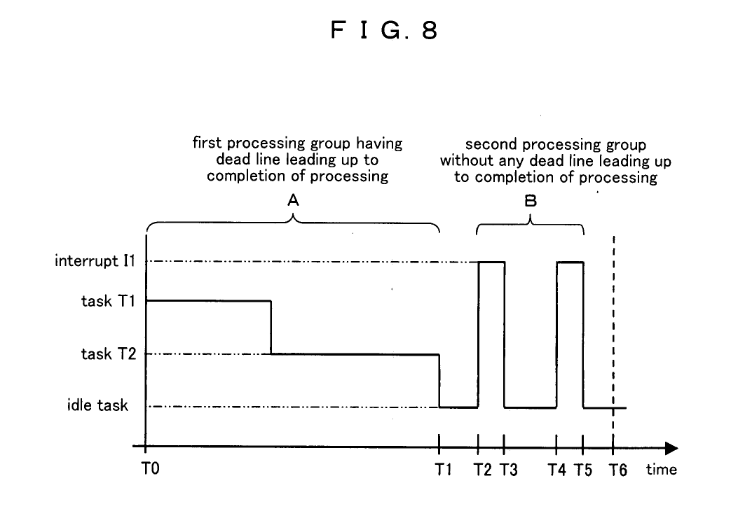

Hereinafter, preferred embodiments of a method and a device for disturbing processing time in a real time operating system according to the present invention are described in detail referring to the drawings. It is assumed that any of the methods and the devices for distributing processing time in the real time operating system according to the preferred embodiments 1-3 includes the five steps, which are the first step S1-fifth step S5 shown in FIG. 7.

### Preferred Embodiment 1

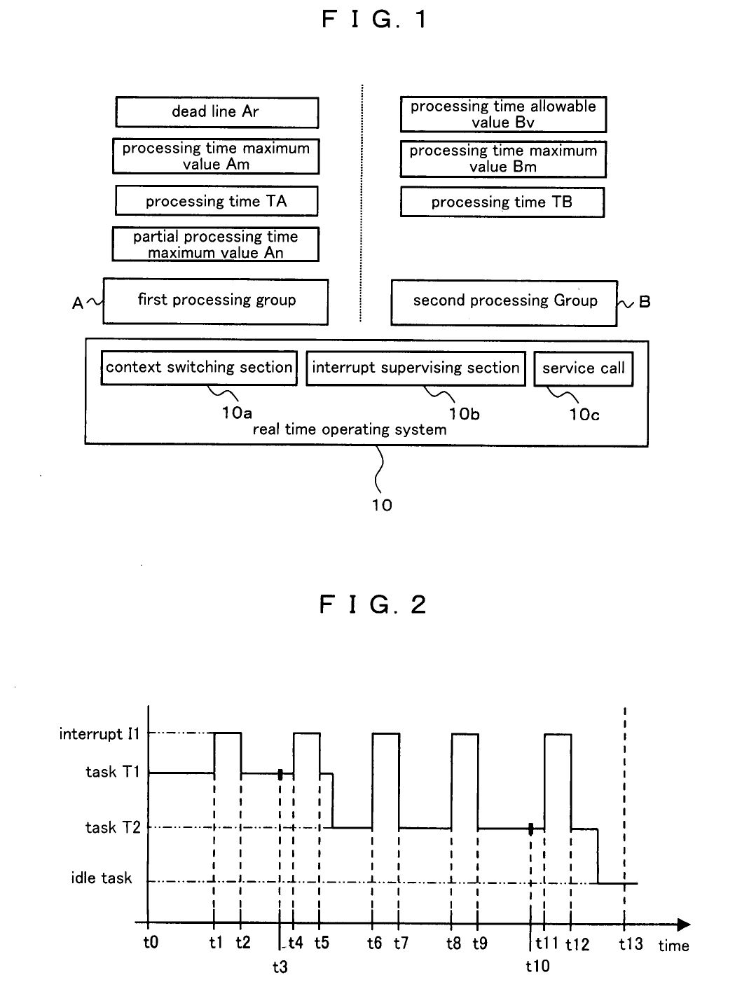

FIG. 1 shows a system configuration of a method for distributing processing time in a real time operating system according to a preferred embodiment 1 of the present invention. In the configuration according to the present preferred embodiment, a first processing group A having a dead line leading up to completion of the processing and a second processing group B without any dead line leading up to completion of the processing are operated on a real time operating system 10.

The first processing group A supervises:
dead line Ar set previously as a maximum tolerance value of time necessary for processing of the first processing group A to be completed;
maximum value of the processing time necessary from start-up to completion of the processing of the first processing group A
processing time TA from the start-up of the processing of the first processing group A; and
maximum value of a partial processing time that is a maximum value of the processing time of the first processing group A from the start-up of the processing of the first processing group A up to a time point when the processing is shifted to the operating system in response to issuance of a service call and the like.

The second processing group B supervises:
processing time allowable value Bv;
maximum value of the processing time Bm of the second processing group B; and
processing time TB from the start-up of the processing of the second processing group B.

The real time operating system 10 comprises at least a context switching section 10a, an interrupt supervising section 10b and a service call 10c, and switches the first processing group A and the second processing group B to each other in response to the issuance of a particular service call and interrupt.

FIG. 2 is a timing chart that shows simple processing flows of the first processing group A and the second processing group B in the preferred embodiment 1. Here, the first processing group A consists of two tasks (task T1 and task T2), and the second processing group B consists of an interrupt (interrupt I1). It is assumed here that the dead line Ar leading up to completion of the processing in the first processing group A is 60 seconds (t13), and the second processing group B generates an activation request every seven seconds. Basically, the interrupt I1 is requested every seven seconds.

In the Step S1, the processing time maximum values Am and Bm necessary from the processing start-up to the processing completion in the first and second processing groups A and B are calculated respectively from logical values and measured data. It is assumed here as follows:
The processing time maximum value Am of the first processing group A is calculated as 46 seconds; and
The processing time maximum value Bm of the second processing group B is calculated as three seconds.

In a similar manner, the partial processing time maximum value An of the first processing group A is calculated from the logical values and the measured data. It is assumed here as follows:
The service call is issued at Time t3 and Time t10 in the first processing group A, and the processing is shifted to the operating system;
The partial processing time maximum value An up to the Time t3 is calculated as 13 seconds; and
The partial processing time maximum value An up to the Time t10 is calculated as 40 seconds.

Next, in the Step S2, a time difference between the dead line Ar and the processing time maximum value Am of the first processing group A (Ar−Am) is calculated. Then, in the Step S3, the calculated time difference (Ar−Am) is set as the processing time allowable value Bv of the second processing group B. In the present example, By =Ar−Am=60−46=14 seconds is set as the processing time allowable value Bv of the second processing group B.

After the processing time allowable value Bv is set, the processing starts at Time t0. The update of the processing time allowable value Bv in the Step S4 is implemented when a context is switched to the first processing group A after the processing of the first processing group B is completed and when the processing is shifted to the operating system in response to the issuance of the service call and the like. It corresponds to the Times t2, t3, t5, t7, t9, t10 and t12. These are the timings of updating the processing time allowable value Bv.

In the Step S5, the processing time allowable value Bv is 14 seconds at the Time t0, and longer than three seconds that is the processing time maximum value Bm of the second processing group B. Therefore, the second processing group B is in an interrupt-allowable state.

When the interrupt of the second processing group B is requested at the Time t1, the processing of the second processing group is implemented. When the processing of the second processing group B starts, a measuring timer of the processing time Ta of the first processing group A is temporarily halted, and thereafter a measuring timer of the processing time TB of the second processing group B is activated.

After the processing of the second processing group B is completed, the processing time TB of the second processing group B is calculated from the measuring timer of the second processing group B at the Time t2. In the case where the processing time TB of the second processing group B is three seconds, the processing time allowable value Bv (14 seconds) is reduced by three seconds to be updated to 11 seconds (14−3=11) in the Step S4. Then, the processing time maximum value Bm of the second processing group B and the processing time allowable value Bv are compared to each other in the Step S5. Because the processing time allowable value Bv, that is 11 seconds, is longer than the processing time maximum value Bm of the second processing group B, that is three seconds, the second processing group B is in the interrupt-allowable state, and the processing is shifted to the first processing group A. Further, the temporary termination of the measuring timer of the processing time TA in the first processing group A is released at the Time t2.

Next, the service call is issued from the first processing group A at the Time t3. When the service call is issued, the processing time TA between the Time t0 when the processing of the first processing group A starts and the Time t3 when the service call is issued is calculated based on the measuring timer of the first processing group A. Assuming that the processing time TA between the processing start-up of the first processing group A and the issuance of the service call (t0→t3) is 13 seconds, the partial processing time maximum value An up to the Time t3 is 13 seconds. The processing time TA and the partial processing time maximum value An are thus equal to each other, therefore, the processing time allowable value By is not updated so as to keep 11 seconds.

At the Times t4, t6 and t8, in a manner similar to the processing at the Time t1, the measuring timer of the processing time TA of the first processing group A is temporarily halted, and the measuring timer of the processing time TB of the second processing group B is activated. At the Times t5, t7 and t9, in a manner similar to the processing at the Time t2, the processing time TB is calculated from the measuring timer of the second processing group B, the processing time allowable value Bv is updated, and the updated processing time allowable value Bv and the processing time maximum value Bm are compared to each other. Then, it is judged whether or not the second processing group B is processable, and then the processing is shifted to the first processing group A. During the operation, the processing time allowable value Bv is sequentially updated (reduced by three seconds), and results in 11 seconds→eight seconds→five seconds.

It is assumed that the processing time allowable value By of the second processing group B is two seconds, and the second processing group B is non-processable at the Time t9, in other words, the processing time allowable value Bv, that is two seconds, is lower than the processing time maximum value Bm, that is three seconds.

After that, when the service call is issued from the first processing group A at the Time t10, the measuring timer of the first processing group A calculates the processing time TA. The processing time TA is a length of time necessary from the processing start-up of the first processing group A (Time t0) to the issuance of the service call (Time t10). It is assumed that the processing time TA necessary from the processing start of the first processing group A by the issuance of the service call is 38 seconds. Because the partial processing time maximum value An up to the Time t10 is 40 seconds, the processing time TA (38 seconds) is shorter by two seconds than the partial processing time maximum value An (40 seconds), and the margin is generated in the processing time. Therefore, the processing time allowable value Bv is updated to the value (2+2=4 seconds) obtained by adding the margin (two seconds) to the before-mentioned value (two seconds). Because the updated processing time allowable value Bv, that is four seconds, is longer than the processing time maximum value Bm (three seconds) of the second processing group B (three seconds), the second processing group B is in the interrupt-allowable state. Such switchover processing from a non-processable state to the interrupt-allowable state is executed by allowing the processing of the second processing group B at the Time t11 through changing a state of the system.

After the second processing group B is processed, at the Time t12, the processing time TB of the second processing group B is calculated from the measuring timer of the second processing group B. When the processing time TB of the second processing group B is two seconds, the processing time allowable value Bv is reduced by two seconds to be updated to two seconds in the Step S4, and the processing time maximum value Bm and the processing time allowable value Bv of the second processing group B are compared to each other in the Step S5. Because the processing time allowable value Bv, that is two seconds, is smaller than the processing time maximum value Bm of the second processing group B, that is three seconds (Bm>Bv), the second processing group B is not set in the interrupt-allowable state but is set in an interrupt-prohibited state, and the processing is shifted to the first processing group A.

In the present preferred embodiment, the processing time allowable value Bv of the second processing group B is set as “time” from the dead line Ar and the processing time maximum value Am of the first processing group A (Bv=Ar−Am). Then, while the processing time allowable value Bv is continuously updated, the processing time allowable value Bv and the processing time maximum value Bm of the second processing group B are compared to each other in each update. Herewith, according to the present preferred embodiment, the second processing group B is in the interrupt-allowable state while the completion of the processing of the first processing group A within the dead line Ar of the first processing group A is guaranteed.

### Preferred Embodiment 2

In the preferred embodiment 1, the time difference between the dead line Ar and the processing time maximum value Am (Ar−Am) of the first processing group A is set as the processing time allowable value Bv of the second processing group B. On the contrary, in a preferred embodiment 2 of the present invention, “processable number of times”, that is calculated from the time difference (Ar−Am), is set as a processing time allowable value Bc of the second processing group B.

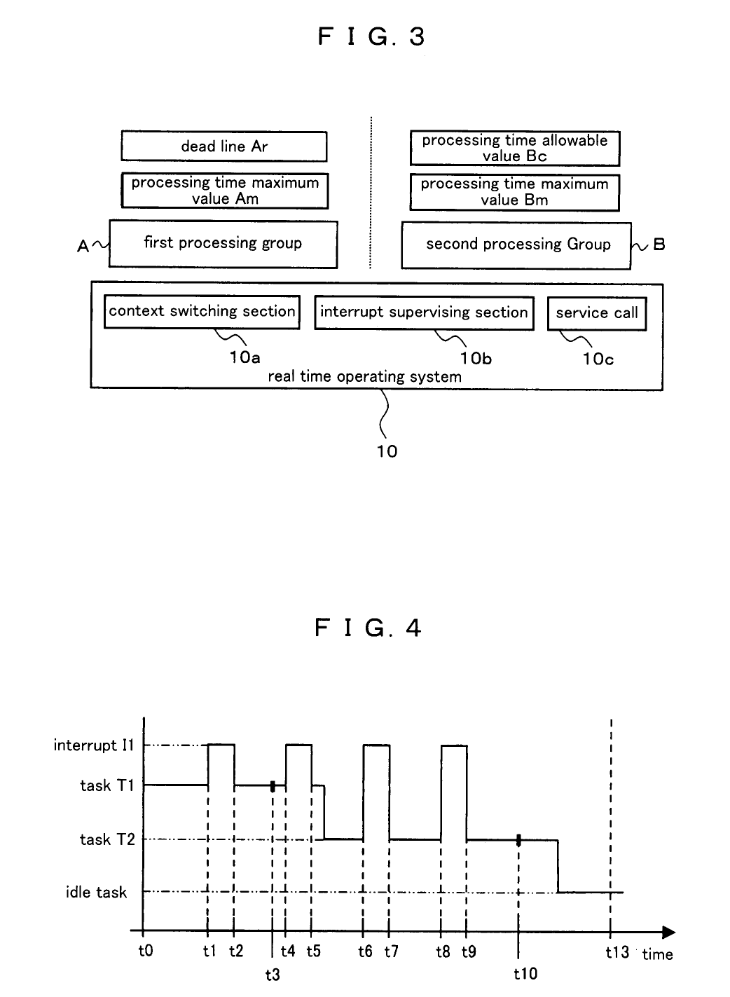

FIG. 3 shows a system configuration of a method for distributing a processing time in a real time operating system according to the preferred embodiment 2. In the configuration according to the present preferred embodiment, a first processing group A having a dead line leading up to completion of the processing and a second processing group B without any dead line leading up to completion of the processing are operated on a real time operating system 10.

The first processing group A supervises:
the dead line Ar leading up to completion of the processing of the first processing group A;
processing time maximum value Am of the first processing group A; and

The second processing group B supervises:
the processing time allowable value Bc;
processing time maximum value Bm of the second processing group B; and

The real time operating system 10 comprises at least a context switching section 10a, an interrupt supervising section 10b and a service call 10c, and switches the first processing group A and the second processing group B to each other based on the issuance of a particular service call and interrupt.

FIG. 4 is a timing chart showing simple processing flows of the first processing group A and the second processing group B in the preferred embodiment 2. The first processing group A consists of two tasks (task T1 and task T2), and the second processing group B consists of an interrupt (interrupt I1). It is assumed here that the dead line Ar leading up to completion of the processing in the first processing group A is 60 seconds (t13), and the interrupt is requested every seven seconds in the second processing group B.

First, in the Step S1, a maximum value of the processing time necessary from the processing start-up to the processing completion of the first and second processing groups A and B is calculated from logical values and measured data. In the present preferred embodiment, it is assumed that the processing time maximum value Am of the first processing group A is calculated as 46 seconds, and the processing time maximum value Bm of the second processing group B is calculated as three seconds.

Next, in the Step S2, a time difference between the dead line Ar and the processing time maximum value Am of the first processing group A (Ar−Am) is calculated. In the Step S3, the processing time allowable value Bc of the second processing group B is calculated from the time difference (Ar−Am). The processing time allowable value Bc of the second processing group B is obtained when the time difference (Ar−Am) is divided by the processing time maximum value Bm of the second processing group B. In the present example, the processing time allowable value Bc of the second processing group B is (Ar−Am)÷Bm=(60−46 seconds)÷three seconds=4, remainder 2. The quotient, that is four, denotes the processable number of times, and is set as the processing time allowable value Bc.

After the processing time allowable value Bc is set, the processing starts at the Time t10. Here, as an example, it is assumed that the update of the processing time allowable value Bc in the Step S4 is implemented when the context is switched to the first processing group A after the processing of the second processing group B is completed. At the Times t2, t5, t7 and t9, switchover of the context is implemented, and further, it is a timing when the processing time allowable value Bc is updated.

In the Step S5, the processing time allowable value Bc is four at the Time t10, that is not lower than one, and it is judged that the second processing group B is in the interrupt-allowable state. When the interrupt of the second processing group B is requested at the Time t1, the processing in the second processing group B is implemented. After implementation of processing in the second processing group B, the processing time allowable value Bc is reduced by one to be updated to three in the Step S4 because the second processing group B was already processed once at the Time t2. In the Step S5, because the processing time allowable value is not yet zero at the time, the second processing group B is assumed to be in the interrupt-allowable state, and the processing is shifted to the first processing group A.

In a similar manner, the interrupt of the second processing group B is requested at the Times t4 and t6, and the processing time allowable value Bc is updated at the Times t5 and t7. Then, the processing time allowable value Bc is compared respectively in order to confirm if the value is zero, and it is judged that the second processing group B is in the interrupt-allowable state because the value is not zero. The processing is then shifted to the first processing group A.

When the interrupt of the second processing group B is requested at the Time t8, and the processing in the second processing group B is implemented, the processing time allowable value Bv is reduced by one to be updated to zero at the Time t9. Because the processing time allowable value Bc is zero at the time, the second processing group B is not made to be in the interrupt-allowable state but is made to be in the interrupt-prohibited state. Then, the processing is shifted to the first processing group A.

In the present preferred embodiment, the processing time allowable value Bc of the second processing group B is previously calculated as the “processable number of times” based on the dead line Ar and the processing time maximum value Am of the first processing group A and the processing time maximum value Bm of the second processing group B. Thereby, it is possible that the second processing group B is in the interrupt-allowable state while the completion of the processing of the first processing group A is guaranteed within the dead line Ar of the first processing group A.

### Preferred Embodiment 3

In the case of the preferred embodiment 2 wherein the processable number of times described above is used as the processing time allowable value, the actual processing time may be shorter than the processing time maximum value depending on a system, for example, in a cache system. More specifically, even though the second processing group B is made to be in the interrupt-allowable state again after the second processing group B is implemented as many times as the processing time allowable value Bc that is previously calculated, the dead line Ar of the first processing group A may be guaranteed. Such a situation is generated when the processable number of times is used as a judgment reference. More specifically, such a situation may be generated because a remainder is possibly generated when the processable number of times is calculated in the formula of (Ar−Am)÷Bm.

In a preferred embodiment 3 of the present invention, therefore, it is judged whether or not the second processing group B is made to be in the interrupt-allowable state again after the processing time allowable value Bc is zero in such a manner that the remainder generated from the formula of (Ar−Am)÷Bm is judged. When it is judged that the interrupt-allowable state is allowed, the second processing group B is made to be in the interrupt-allowable state.

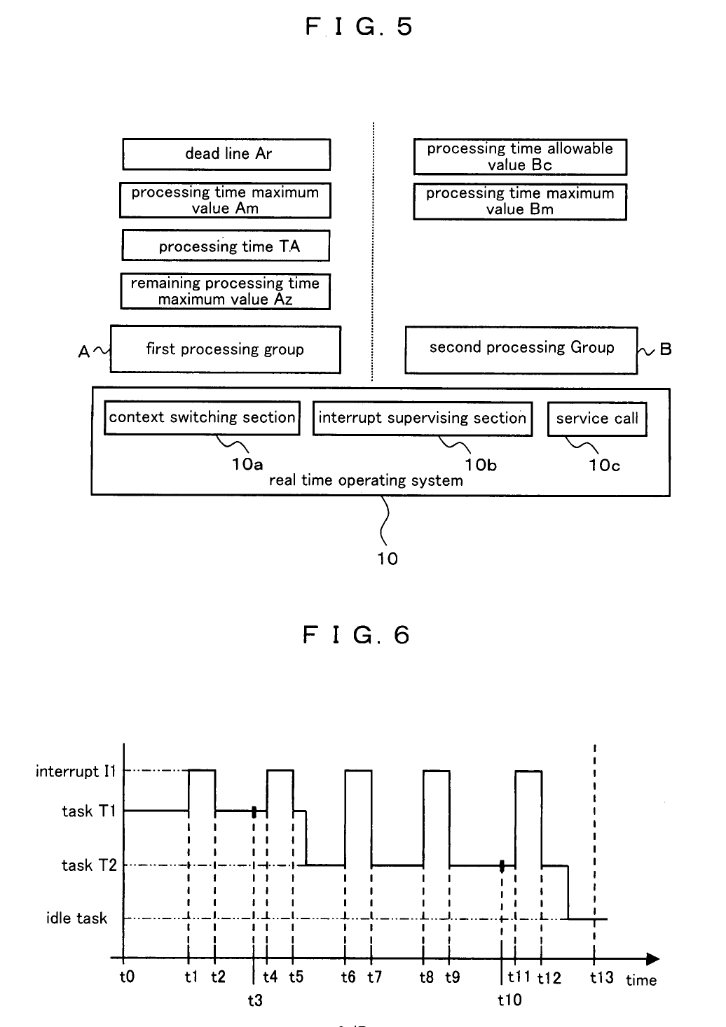

FIG. 5 shows a system configuration of a method for distributing processing time in a real time operating system according to the preferred embodiment 3. In the configuration according to the present preferred embodiment, it is assumed that a first processing group A having a dead line leading up to completion of the processing and a second processing group B free of any dead line leading up to completion of the processing are operated on a real time operating system 10.

The first processing group A supervises the processing time TA form start-up of the first processing group A and a remaining processing time maximum value Az from the issuance of the service call of the first processing group A to the processing completion of the first processing group A at a dead line Ar, a processing time maximum vale Am thereof and each service call issued during the processing of the first processing group A. The processing time TA is measured by means of, for example, a timer resource. The second processing group B supervises the processing time allowable value Bc and the processing time maximum value Bm of the second processing group B.

The real time operating system 10 comprises at least a context switching section 10a, an interrupt supervising section 10b and a service call 10c, and switches the first processing group A and the second processing group B to each other in response to the issuance of a particular service call and interrupt.

FIG. 6 is a timing chart showing simple processing flows of the first processing group A and the second processing group B in the preferred embodiment 3. Here, the first processing group A consists of two tasks (task T1 and task T2), and the second processing group B consists of an interrupt (interrupt I1). It is assumed here that the dead line Ar leading up to completion of the processing of the first processing group A is 60 seconds (t13), and the interrupt is requested every seven seconds in the second processing group B.

First, in the Step S1, the following values are calculated from the logical values and the measured data in the first and second processing groups A and B. More specifically, the processing time maximum value from the processing start-up to the processing completion and the remaining processing time maximum value Az from the issuance of the service call to the processing completion of the first processing group A are calculated. In the present preferred embodiment, it is assumed that the following values are calculated as follows:
The processing time maximum value Am of the first processing group A is calculated as 46 seconds;
The processing time maximum value Bm of the second processing group B is calculated as three seconds;
The remaining processing time maximum value Az at the Time t3 is calculated as 33 seconds; and
The remaining processing time maximum value Az at the Time t10 is calculated as 6 seconds.

Next, in the Step S2, a time difference between the dead line Ar and the processing time maximum value Am of the first processing group A (Ar−Am) is calculated. In the Step S3, the processing time allowable value Bc of the second processing group B is calculated from the time difference (Ar−Am). The processing time allowable value Bc of the second processing group B is obtained when the time difference (Ar−Am) is divided by the processing time maximum value Bm of the second processing group B. In the present preferred embodiment, (time difference−14)÷(processing time maximum value Bm=3)=4, remainder 2. The quotient, that is four, is set as the processing time allowable value Bc.

After the processing time allowable value Bc is set, the processing starts at the Time t10. In the present example, when the processing time allowable value Bc is one or more, the update of the processing time allowable value Bc in the Step S4 is implemented when the context is switched to the first processing group A after the processing of the second processing group B is completed. At the Times t2, t5, t7, t9 and t12, the context is switched, and further, it is the timing where the processing time allowable value Bc is updated. When the processing time allowable value Bc is zero, the update of the processing time allowable value Bc in the Step S4 is implemented when the processing is shifted to the operating system in response to the issuance of the service call and the like during the processing of the first processing group A. The Times t3 and t10 is a time when the processing is executed in the operating system, and it is a timing where the processing time allowable value Bc is updated.

In the Step S5, the processing time allowable value Bc is four at the Time t0, and it is judged that the second processing group B is in the interrupt-allowable state. When the processing of the first processing group A starts at the Time t0, the measuring timer of the processing time TA of the first processing group A is activated.

When the interrupt of the second processing group B is requested at the time t1, the processing of the second processing group B is executed. After the processing of the second processing group B is implemented, the processing time allowable value Bc is reduced by one to be updated to three in the Step S4 because the second processing group B was already processed once at the Time t2. In the Step S5, because the processing time allowable value is not yet zero at the time, the second processing group B is in the interrupt-allowable state, and the processing is shifted to the first processing group A.

When the service call is issued at the Time t3, the processing time allowable value Bc is not updated because the relevant value is at least one. When the interrupt of the second processing group B is requested at the Times t4 and t6, the processing time allowable value Bc is updated at the Times t5 and t7, and each of the updated values is compared to detect if they are zero. If the processing time allowable value Bc is not zero at either of the timings, the second processing group B is in the interrupt-allowable state, and the processing is shifted to the first processing group A.

When the interrupt of the second processing group B is requested at the Time t8, and the processing of the second processing group B is implemented, the processing time allowable value Bc is reduced by one to be updated to zero at the Time t9. When the processing time allowable value Bc becomes zero, the second processing group B is not in the interrupt-allowable state but is in the interrupt-prohibited state, and the processing is shifted to the first processing group A.

Thereafter, it is assumed that the service call is issued at the Time t10 during the processing of the first processing group A. Because the processing time allowable value Bc is zero at the time, the processing time allowable value Bc is updated. The processing time TA and the dead line Ar are compared to each other so that a remaining time leading up to the dead line is calculated. It is assumed in the present example that the processing time TA when the service call is issued at the Time t10 is 50 seconds. At the time, the remaining processing time maximum value Az is six seconds, and the dead line Ar is 60 seconds. Therefore, (dead line Ar)−(processing time TA)−(remaining processing time maximum value Az)=4 seconds, remainder 4. Because the processing time maximum value Bm of the second processing group B is three seconds, the second processing group B can be inserted again. When the fact is known, the system state is changed from the interrupt-prohibited state to the interrupt-allowable state.

When the system state is changed, the processing of the second processing group B is implemented at the Time t11. After the processing of the second processing group B is implemented, the second processing group B is not in the interrupt-allowable state but in the interrupt-prohibited state at the Time t12, and the processing is shifted to the first processing group A.

According to the present preferred embodiment, the criterion error in the case where the processable number of times is used as the processing time allowable value Bc, is eliminated, and the potential of the second processing group B free of any dead line leading up to completion of the processing can be expanded. As a result, it enables the more detailed control.

Though preferred embodiments of this invention have been described in detail, it will be understood that various modifications may be made therein, and it is intended to cover in the appended claims all such modifications as fall within the true spirit and scope of this invention.

What is claimed is:

1. A method of processing time distribution in a real time operating system including a first processing group having a dead line leading up to completion of the processing and a second processing group without any dead line leading up to completion of the processing, comprises:
a first step for calculating a processing time necessary from start to end of processing of the first processing group and the second processing group;
a second step for calculating a time difference between a dead line previously set as a maximum tolerance value of the processing time necessary by completion of the processing of the first processing group, and the calculated processing time;
a third step for setting an initial value of a processing time allowable value of the second processing group based on the time difference;
a fourth step for updating the processing time allowable value at the time of processing in the operating system; and
a fifth step for judging whether or not the second processing group can be processed based on the updated processing time allowable value.

2. The method of the processing time distribution in the real time operating system as claimed in claim 1, wherein
a maximum values of the processing time necessary from the start by the end of the processing of the first and second processing groups are calculated as the processing time in the respective groups in the first step.

3. The method of the processing time distribution in the real time operating system as claimed in claim 2, wherein
the processing time allowable value in the second processing group and the processing time are compared to each other at the time of the processing in the operating system, and it is judged that the second processing group is in an executable state when the processing time allowable value is larger in the fifth step.

4. The method of the processing time distribution in the real time operating system as claimed in claim 1, wherein
processable number of times of the second processing group is calculated from the time difference, and the processable number of times is set as an initial value of the processing time allowable value of the second processing group in the third step, and
it is judged that the second processing group is in an executable state when the processing time allowable value is at least zero in the fifth step.

5. The method of the processing time distribution in the real time operating system as claimed in claim 1, wherein
a plurality of calculation methods of the processing time allowable values is prepared, and a calculation method of the processing time allowable values is changed when it is judged that the second processing group is not in an executable state based on the processing time allowable values in the fifth step.

6. The method of the processing time distribution in the real time operating system as claimed in claim 1, wherein
the time of the processing in the operating system is the time when a context is changed to the first processing group implemented after the processing of the second processing group is completed.

7. The method of the processing time distribution in the real time operating system as claimed in claim 1, wherein
the time of the processing in the operating system is the time when the processing is shifted to the operating system during the processing of the first processing group.

8. The method of the processing time distribution in the real time operating system as claimed in claim 3, wherein
an actual processing time of the second processing group necessary from the start by the end of the processing thereof is measured, and the processing time allowable value is updated based on the measured actual processing time of the second processing group in the fourth step.

9. The method of the processing time distribution in the real time operating system as claimed in claim 3, wherein,
a processing time maximum value of the first processing group necessary from the start of the processing thereof by a time point when the processing is shifted to the operating system is calculated,
an actual processing time of the first processing group necessary from the start of the processing thereof by the time point when the processing is shifted to the operating system is calculated, and
the processing time allowable value is updated based on the processing time maximum value and the actual processing time of the first processing group in the fourth step.

10. A device for processing time distribution in a real time operating system comprising:
a processing time calculator for calculating a processing time necessary from start by end of processing of a first processing group having a dead line leading up to completion of the processing and a second processing group without any dead line leading up to completion of the processing;
a time difference calculator for calculating a time difference between a dead line previously set as a maximum tolerance value of the time necessary by completion of the first processing group, and the calculated processing time;
a processing time allowable value calculator for calculating a processing time allowable value of the second processing group based on the calculated time difference; and
a judger for changing a state of the system by judging whether or not the second processing group is made to be in an executable state based on the calculated processing time allowable value.
